(19) United States
(12) Patent Application Publication
(10) Pub. No.: US 2015/0330089 A1
(43) Pub. Date: Nov. 19, 2015

(54) PRESSURE-ASSIST HOPPER FOR INTEGRATED HANDHELD TEXTURE SPRAYER

(71) Applicant: GRACO MINNESOTA INC., Minneapolis, MN (US)

(72) Inventors: Eric J. Finstad, Rogers, MN (US); Jeromy D. Horning, Albertville, MN (US); Robert W. Kinne, Columbia Heights, MN (US); Bret A. Deneson, Otsego, MN (US)

(21) Appl. No.: 14/762,646

(22) PCT Filed: Jan. 24, 2014
(86) PCT No.: PCT/US2014/012951

§ 371 Date: Jul. 22, 2015

Related U.S. Application Data
(60) Provisional application No. 61/756,117, filed on Jan. 24, 2013.

(51) Int. Cl. E04F 21/12; B05B 7/14; B05B 7/24

(52) U.S. Cl. CPC E04F 21/12; B05B 7/2416; B05B 7/1413; B05B 7/1486

(57) ABSTRACT

A handheld sprayer comprises a housing, a turbine, a spray tip, a hopper and a bleed line. An air flow passage extends through the housing. The turbine is configured to generate an airflow within the air flow passage. The spray tip is positioned to receive airflow from the air flow passage. The hopper is connected to the housing and is configured to discharge a fluid into the air flow passage. The bleed line is configured to direct a portion of the airflow from the turbine to the hopper. Additionally, a method for spraying a fluid from a handheld sprayer comprises directing a portion of an airflow from a turbine into a hopper to assist in discharging fluid from the hopper into a passage connected to a spray tip and the airflow from the turbine.

### BACKGROUND

The present invention is related to handheld sprayers, and in particular to systems and methods for controlling airflow for integrated handheld sprayers.

Handheld texture sprayers are utilized, for example, to apply coatings to walls, ceilings, and/or other surfaces. These coatings may include, for example, “knockdown” finishes, “popcorn” finishes, and fine “orange peel” finishes. Texture sprayers are supplied a viscous material, such as, for example, drywall mud from a separate tank or an attached hopper. An airflow provided to the sprayer atomizes the fluid into a spray that is applied to a surface in order to create a desired finish.

In the past, the airflow has been provided from, for example, an external air compressor. These air compressors are often bulky and limit the mobility and convenience of the texture sprayer. To provide portability, these external air compressors have been replaced with a local airflow source, such as a turbine. One such portable texture sprayer is disclosed in U.S. Pat. No. 7,731,104. While providing portability, these texture sprayers lack the control desirable for providing specific and quality texture finishes. These texture sprayers are limited in both the type and quality of finish they can provide. It is desirable to provide improved control for handheld sprayers in order to provide a greater range and greater quality of the finishes created by the sprayer.

### SUMMARY

A handheld sprayer comprises a housing, a turbine, a spray tip, a hopper and a bleed line. An air flow passage extends through the housing. The turbine is configured to generate an airflow within the air flow passage. The spray tip is positioned to receive airflow from the air flow passage. The hopper is connected to the housing and is configured to discharge a fluid into the air flow passage. The bleed line is configured to direct a portion of the airflow from the turbine to the hopper.

A method for spraying a fluid from a handheld sprayer comprises generating an airflow with a turbine, directing the airflow through a passage within the sprayer to a spray tip, selectively discharging a fluid into the passage from a hopper for spraying through the spray tip, and directing a portion of the airflow from the turbine into the hopper to assist in discharging the fluid.

### BRIEF DESCRIPTION OF THE DRAWINGS

FIG. 1 is a perspective view of an integrated handheld texture sprayer having a turbine, a dispenser and a hopper.

FIG. 2 is an exploded view of the texture sprayer of FIG. 1 showing an air flow path from the turbine, through a plenum and piston within the dispenser and to a spray tip.

FIG. 3 is cross-sectional view of the texture sprayer of FIG. 2 showing interconnection of the turbine, a trigger, the piston and the spray tip.

FIG. 4 is a cross-sectional view of an alternative embodiment of the texture sprayer of FIG. 3 including a pressure-assist hopper with a turbine bleed line.

FIG. 5 is a schematic of the bleed line of FIG. 4 including a check valve, an orifice and a variable valve.

### DETAILED DESCRIPTION

Disclosed herein is a handheld texture sprayer that provides pressurization of a hopper containing the spray fluid utilizing compressed air from a turbine that generates an airflow to dispense the fluid at a spray tip. The handheld texture sprayer includes a housing, a turbine, a spray tip, and a hopper. An air flow passage extends through the housing and carries an airflow generated by the turbine. The hopper is connected to the housing and holds fluid that is provided to the airflow passage for spraying. The sprayed fluid is projected through the spray tip for application to a surface. In one embodiment, a bleed line connects an output of the turbine to the hopper, and the hopper includes a sealable lid. The bleed line may include a check valve, an orifice and/or a variable valve to control flow through the bleed line.

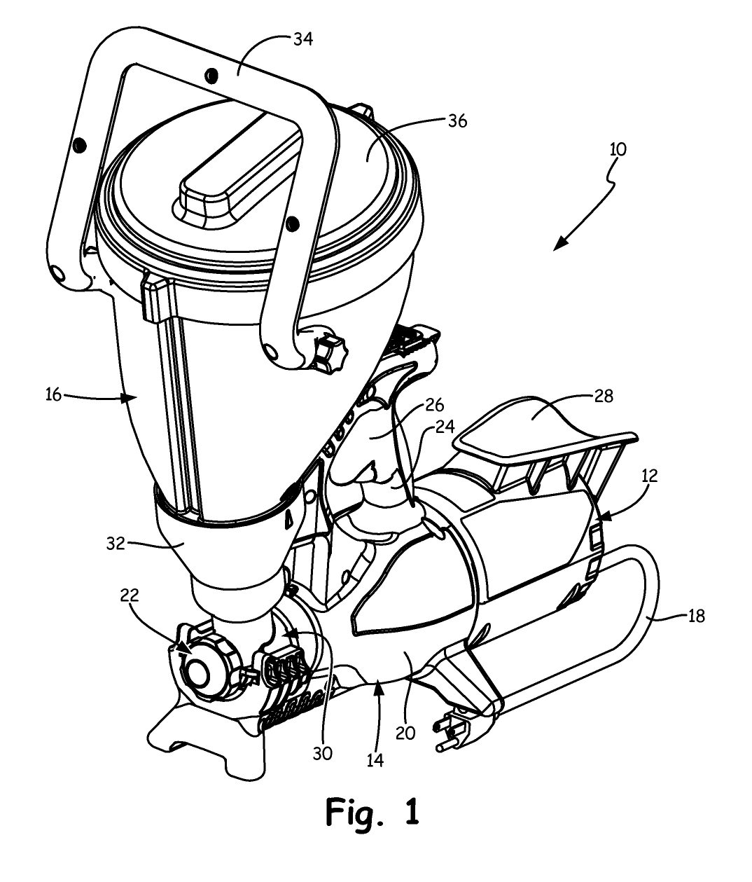

FIG. 1 is a perspective view of integrated handheld texture sprayer 10 having turbine 12, dispenser 14 and hopper 16. In the described embodiments, sprayer 10 may be used to dispense a fluid having a texturizing additive, which is present in hopper 16. Dispenser 14 utilizes an airflow generated by turbine 12 to discharge the fluid in a spray pattern conducive for forming texturized finishes.

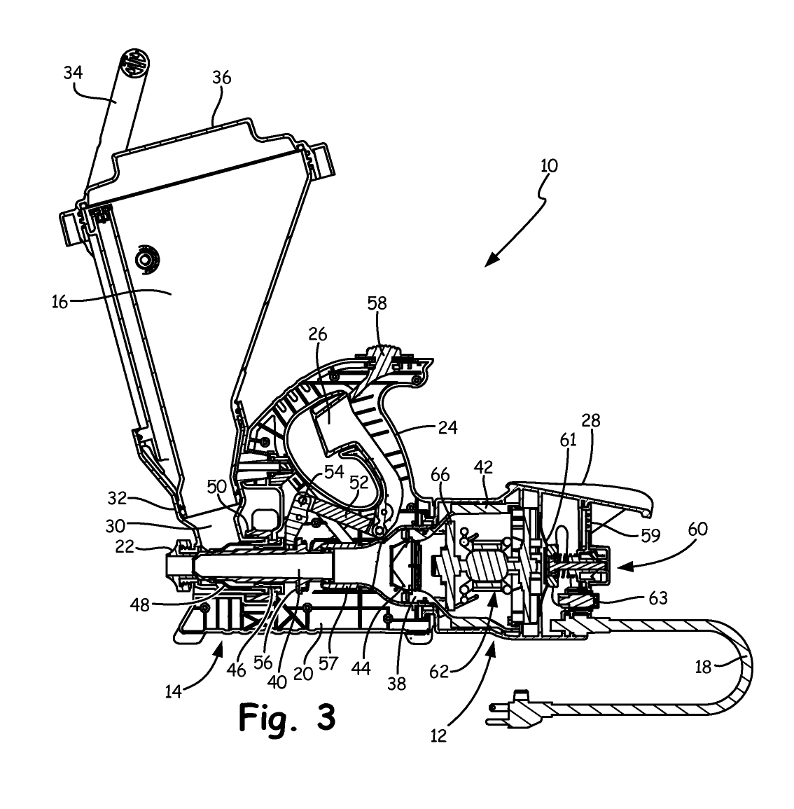

Turbine 12 utilizes electrical power from cord 18 to generate a flow of compressed air for pushing liquid from hopper 16 through dispenser 14. Turbine 12 is inserted into housing 20 of dispenser 14 to fluidly interact with spray tip 22. Housing 20 includes handle 24 into which is integrated trigger 26. An operator of sprayer 10 grasps handle 24 with a hand while resting a forearm on pad 28 so that trigger 26 can be actuated with one or more fingers. Turbine 12 is activated via a power switch (FIG. 3) in order to produce the pressurized air via rotation of an impeller, fan or the like. Upon actuation of trigger 26, a valve behind spray tip 22 is opened that simultaneously allows fluid from hopper 16 to enter mix chamber 30 through funnel 32, and air from turbine 12 to enter mix chamber 30 through housing 20. Spray tip 22 is interchangeable so that different patterns can be sprayed. For texture sprayers, spray tip 22 includes an opening sufficiently large to discharge fluid and texturizing particles. Hopper 16 also includes handle 34 and lid 36 so that sprayer 10 can be easily grasped to orientate spray tip 22 upward without fluid overflowing from hopper 16.

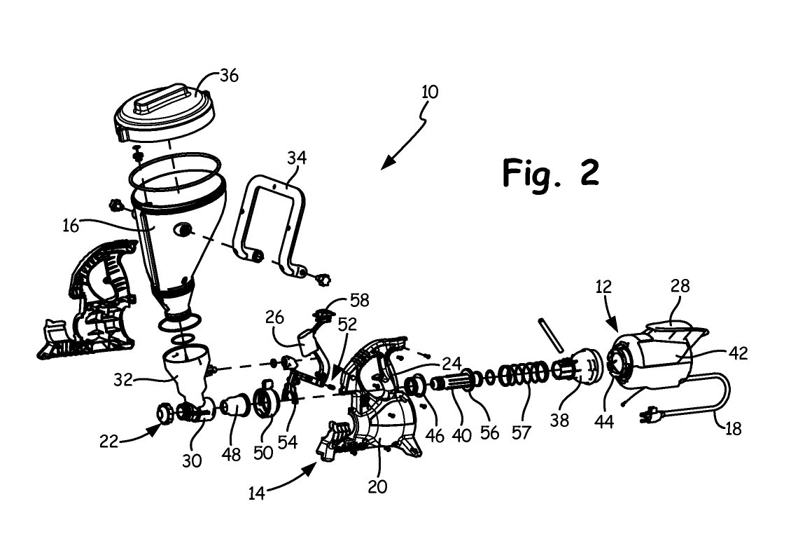

FIG. 2 is an exploded view of texture sprayer 10 of FIG. 1 showing an air flow path from turbine 12, through plenum 38 and piston 40 within dispenser 14, to spray tip 22. Plenum 38 connects to housing 42 of turbine 12 to receive pressurized air from outlet 44. Piston 40 is slidable between plenum 38 and spray tip 22. Piston 40 is supported within housing 20 and mix chamber 30 via bushing 46 and sleeve 48. Collar 50 couples mix chamber 30 to housing 20, with bushing 46 and sleeve 48 being retained between via flanges (as can be seen in FIG. 3). Spray tip 20 is threaded onto an outlet opening in mix chamber 30. Trigger 26 is coupled to piston 40 via linkage 52 and yoke 54, which engages flange 56 on piston 40. Spring 57 is positioned around portions of plenum 38 and piston 40. Trigger lock 58 is slidable within housing 20 above handle 24 to limit movement of trigger 26.

As will be discussed in more detail with reference to FIG. 3, turbine 12 generates an airflow that passes from turbine exit 44 into plenum 38, which directs the airflow into piston 40 that extends through housing 20 to spray tip 22. Piston 40 is biased toward spray tip 22 via spring 57 to prevent fluid within hopper 16 from entering mix chamber 30 without actuation of trigger 26. Retraction of trigger 26 into handle 24 pulls piston 40 away from spray tip 22 via interaction of linkage 52 and yoke 54 with flange 56. Fluid stored within hopper 16 is allowed to drop, or otherwise flow, into mix chamber 30 and, with piston 40 disengaged from spay tip 22, the fluid is forced into and out of spray tip 22 by the passage of air from piston 40 to spray tip 22.

FIG. 3 is cross-sectional view of texture sprayer 10 of FIG. 2 showing interconnection of turbine 12, plenum 38, piston 40, trigger 26 and spray tip 22. Air is permitted into housing 20 of sprayer 10 via inlet vent 59. In the embodiment shown, flow of air from inlet vent 59 into turbine inlet 61 of turbine 12 is controlled with airflow control 60. Motor 62 is disposed within housing 20 between turbine inlet 61 and plenum 38. Motor 62 may comprise any suitable AC or DC magneto-electric machine that produces rotational output. Thus, activation of motor 62 causes fan 66 to draw air through inlet vent 59 and turbine inlet 61. Motor 62 is activated by switch 63, which may comprise a rocker switch that allows power from cord 18 to motor 62. Thus, motor 62 and turbine 12 provide a continuous flow of air through sprayer 12 so long a switch 63 is activated.

Turbine 12 pushes air into plenum 38 at turbine outlet 44. Piston 40 guides air from plenum 40 to spray tip 22. Spray tip 22 and piston 40 form a seal when engaged in a closed position to prevent air from being in fluid communication with mix chamber 30. Spring 57 pushes between flange 56 and plenum 38 to bias piston 40 to the closed position.

In order to move piston 40 to an open position, trigger 26 is translated, such as by an operator of sprayer 10, away from spray tip 22 (to the right in FIG. 3). Linkage 52 pulls yoke 54 to push flange 56 and piston 40 to an open position away from spray tip 22 such that mix chamber 30 is put into fluid communication with airflow from piston 40.

Moving piston 40 from the closed position to the open position allows fluid from within hopper 16 that is present within mix chamber 30 to enter the air flow path between spray tip 22 and piston 40. In one embodiment, the fluid is pushed into the air flow path primarily via gravity. Additionally, the flow of compressed air between piston 40 and spray tip 22 generates a slight vacuum that pulls in fluid from hopper 16. As such, the flow of air through piston 40 pulls the fluid along through spray tip 22.

The pattern of the sprayed fluid can be adjusted by changing the amount that trigger 26 is actuated. Retracting trigger 26 further into handle 24 allows for more fluid to enter spray tip 22, thereby resulting in a more dense spray pattern. Trigger lock 58 is adjustable to limit the movement of trigger 26. For example, trigger lock 58 can be locked into different positions along the top of handle 24 to provide a barrier to translation of trigger 26 into handle 24. Trigger lock 58 is provided on handle 24 in a location convenient for an operator of sprayer 12 to access, such as with a thumb. Furthermore, the spray pattern can be adjusted by swapping out spray tip 22 for other spray tips having different sized openings that will widen or narrow the pattern of discharged fluid from sprayer 10.

Integrated handheld texture sprayer 10 of the present invention may include other features not described above or that elaborate on the features described above. For example, the present invention is directed to a pressure-assist mechanism that facilitates flow of liquid from hopper 16 to mix chamber 30 and into the flow of pressurized air generated by turbine 12. Specifically, a portion of the pressurized airflow generated by turbine 12 can be directed into hopper 12 to push the fluid toward mix chamber 30.

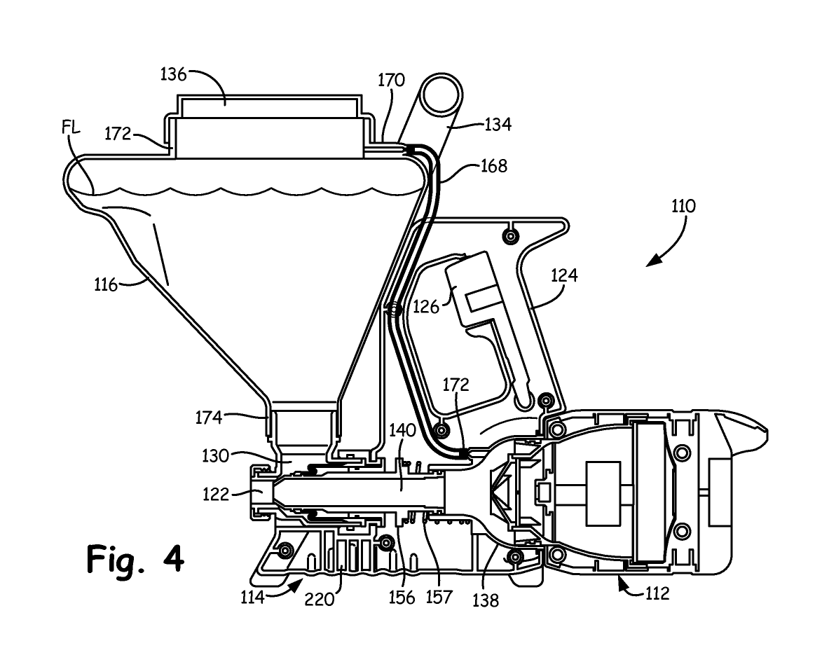

FIG. 4 is a cross-sectional view of an alternative embodiment of texture sprayer 10 of FIG. 3 in which texture sprayer 110 includes pressure-assist hopper 116. Texture sprayer 110 includes similar components as texture sprayer 10 of FIG. 3, which are labeled with 100-series numerals. Texture sprayer 110 additionally includes bleed line 168 extending between hopper fitting 170 and plenum fitting 172. Hopper 116 also includes flange 172, to which lid 136 is mounted and from which hopper fitting 170 extends, and outlet 174, which connects to housing 120 at mix chamber 130.

Turbine 112 provides compressed air to plenum 138, which, through piston 140, feeds spray tip 122. Spring 157 engages flange 156 to bias piston 140 toward spray tip 122. Trigger 126 can be actuated to pull piston 140 away from spray tip 122 via a linkage (not shown) that engages flange 156. Thus, any fluid disposed within mix chamber 130 will be forced through spray tip 122 when piston 140 retracts while turbine 112 is operating. In order to assist with flow of fluid from hopper 116 to spray tip 122, sprayer 110 is provided with an air-assist mechanism that pressurizes the interior of hopper 116.

When powered, turbine 112 continuously provides compressed air to spray tip 122. Bleed line 168 is configured to redirect a portion of the compressed air from plenum 138 to the interior of hopper 116. In one embodiment, bleed line 168 comprises a flexible tube or hose that extends between hopper fitting 170 and plenum fitting 172.

Fitting 172 provides a tap-off point from plenum 138 that supplies bleed line 168 with compressed air from turbine 112. In one embodiment, fitting 172 comprises a cylindrical extension from plenum 138 around which bleed line 168 is fitted. Fitting 170 provides a feed point into hopper 116 that receives compressed air from bleed line 168. In one embodiment, fitting 170 comprises a cylindrical extension from hopper 116 around which bleed line 168 is fitted. In various embodiments, fittings 170 and 172 may be provided with barbs or the like to inhibit dislodgment of bleed line 168 from the fittings.

Compressed air from bleed line 168 is directed into an upper portion of hopper 116 near lid 136. In the depicted embodiment, fitting 170 penetrates into hopper 116 at flange 172. Lid 136 is configured to mate with flange 172 to seal liquid within hopper 116. Lid 136 may be joined to flange 172 via any suitable means, such as a snap fitting or a threaded connection. Compressed air introduced into hopper 116 enters between lid 136 and fluid line FL, thereby pressurizing the interior of hopper 116 and forcing the fluid toward outlet 174 and mix chamber 130.

Pressurization of hopper 116 results in higher and more consistent flow rates between hopper 116 and mix chamber 130. Additionally, the pressurization reduces the potential for pack out, wherein mix chamber 130 becomes clogged with texture material added to the fluid of hopper 116. Pressurization of hopper 116 thus enables spraying of a larger array of materials, with different finishes, textures, mixture rates and viscosities. Additionally, the presence of lid 136, which facilitates generation of the pressurized hopper, also allows for sprayer 110 to be utilized in a wider array of orientations without spilling fluid from hopper 116. The use of an external air supply is eliminated due to the presence of integrated turbine 112.

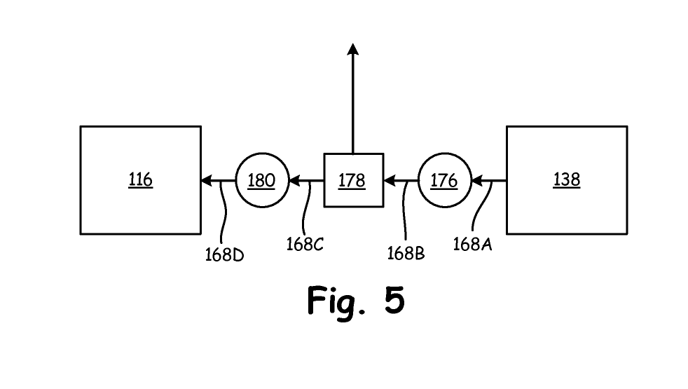

FIG. 5 is a schematic of bleed line 168 of FIG. 4 that connects plenum 138 and hopper 116, and includes orifice 176, variable valve 178 and check valve 180. In the embodiment of FIG. 5, bleed line 168 is shown having segments 168A-168D. Although FIG. 5 shows the inclusion of orifice 176, variable valve 178 and check valve 180, such components may be used individually or in any other combination having fewer components than what is shown.

Orifice 176 is positioned in bleed line between segments 168A and 168B. Orifice 176 is used to restrict flow through bleed line 168 in order to reduce the flow of compressed air bled at fitting 172. Thus, orifice 176 includes an opening having a diameter smaller than the inner diameter of bleed line 168. Thus, the size of orifice 176 can be selected to provide a desired amount of pressurization to hopper 116, based on the amount of pressurized air provided by turbine 112.

Variable valve 178 is positioned in bleed line between segments 168B and 168C. Variable valve 178 comprises an adjustable valve that can restrict the flow of compressed air bled at fitting 172. Variable valve 178 includes a control (not shown), such as a knob, accessible from the exterior of housing 120 (FIG. 4). In a fully open position, variable valve 178 may provide no restriction of airflow. In a fully closed position, variable valve 178 may close-off all airflow through bleed line 168. Variable valve 178 can be manually set with the control to any intermediate position between fully open and fully closed. Thus, variable valve 178 can be used to provide a desired amount of pressurization to hopper 116, based on the amount of pressurized air provided by turbine 112. Variable valve 178 may comprise any suitable valve as is known in the art.

Check valve 180 is positioned in bleed line between segments 168C and 168D. Check valve 180 is positioned proximate hopper 116 and, in one embodiment, can be positioned directly between fitting 170 (FIG. 4) and segment 168D of bleed line 168. Check valve 180 is configured to allow one-way flow through the valve. Thus, check valve 180 is employed to allow airflow from plenum 138 to hopper 116, but to prevent fluid of liquid from hopper 116 to plenum 138. It is desirable to prevent spray fluid from hopper 116 from migrating upstream (relative to the direction of airflow) to prevent fouling of turbine 112. Check valve 180 may comprise any suitable valve as is known in the art.

As discussed above, pressurization of a handheld texture sprayer is desirable to assist feeding spray material to the spray tip. Orifice 176, variable valve 178 and check valve 180 provide additional control over fluid through the sprayer to further enhance the quality of the sprayed finish and the performance of the sprayer, including the turbine.

Although the present invention has been described with reference to preferred embodiments, workers skilled in the art will recognize that changes may be made in form and detail without departing from the spirit and scope of the invention.

1. A handheld sprayer comprising:
a housing through which an air flow passage extends;
a turbine configured to generate an airflow within the air flow passage;
a spray tip positioned to receive airflow from the air flow passage;
a hopper connected to the housing and configured to discharge a fluid into the air flow passage; and
a bleed line configured to direct a portion of the airflow from the turbine to the hopper.

2. The handheld sprayer of claim 1 wherein the bleed line extends between an outlet of the turbine and an upper opening of the hopper.

3. The handheld sprayer of claim 1 wherein the bleed line extends through a handle in the housing.

4. The handheld sprayer of claim 1 wherein the hopper is pressurized by the portion of the airflow directed into the hopper.

5. The handheld sprayer of claim 1 wherein the hopper comprises:
an outlet discharging into the housing;
an inlet opening;
a bleed line fitting disposed proximate the inlet opening; and
a lid covering the inlet opening.

6. The handheld sprayer of claim 1 wherein the housing defines a mix chamber at a junction between the air flow passage and the spray tip, and wherein the hopper discharges into the mix chamber.

7. The handheld sprayer of claim 1 wherein the air flow passage comprises:
a plenum connected to an outlet of the turbine; and
a piston extending from the plenum to the spray tip.

8. The handheld sprayer of claim 7 and further comprising:
a trigger mounted to the housing and configured to retract the piston from the spray tip to allow fluid from the hopper into the air flow passage.

9. The handheld sprayer of claim 1 and further comprising a check valve positioned to prevent fluid from within the hopper to flow through the bleed line.

10. The handheld sprayer of claim 1 wherein the bleed line includes:
a variable valve that controls the flow of the portion of the airflow through the bleed line.

11. The handheld sprayer of claim 10 wherein the variable valve discharges some of the portion of the airflow overboard.

12. The handheld sprayer of claim 1 wherein the bleed line includes an orifice to restrict flow through the bleed line from the turbine to the hopper.

13. A method for spraying a fluid from a handheld sprayer, the method comprising:
generating an airflow with a turbine;
directing the airflow through a passage within the sprayer to a spray tip;
selectively discharging a fluid into the passage from a hopper for spraying through the spray tip; and
directing a portion of the airflow from the turbine into the hopper to assist in discharging the fluid.

14. The method of claim 13 and further comprising pressurizing the hopper with the portion of the airflow.

15. The method of claim 13 and further comprising sealing an access opening in the hopper with a lid.

16. The method of claim 13 and further comprising restricting airflow between the turbine and the hopper with an orifice.

17. The method of claim 13 and further comprising controlling airflow between the turbine and the hopper with a variable valve.

18. The method of claim 13 and further comprising preventing flow of fluid from the hopper to the turbine with a check valve.

19. A handheld texture sprayer comprising:
a housing through which an air flow passage extends;
a turbine configured to generate an airflow within the air flow passage;
a spray tip positioned to receive airflow from the air flow passage;
a hopper connected to the housing and configured to discharge a fluid into the air flow passage, the hopper being pressurized by the turbine.

20. The handheld texture sprayer of claim 19 and further comprising:
a hopper comprising:
an outlet discharging into the housing;
an inlet opening; and
a lid covering the inlet opening; and
a bleed line connecting the hopper and the turbine.
